(19) United States
(12) Patent Application Publication
(10) Pub. No.: US 2015/0160746 A1
(43) Pub. Date: Jun. 11, 2015

(54) PHASED INFORMATION PROVIDING SYSTEM AND METHOD

(71) Applicant: Si-Han Kim, Seoul (KR)

(72) Inventor: Si-Han Kim, Seoul (KR)

(21) Appl. No.: 14/360,554

(22) PCT Filed: Nov. 26, 2012
(86) PCT No.: PCT/KR2012/010021

§ 371 Date: Feb. 4, 2015

(30) Foreign Application Priority Data
Nov. 24, 2011 (KR) 10-2011-0123360
Feb. 1, 2012 (KR) 10-2012-0010491

(51) Int. Cl. G06F 3/041

(52) U.S. Cl. CPC G06F 3/041

(57) ABSTRACT

In a terminal including a display unit, a central processing unit, and an input unit, when a phasic operation command having a specific phase is input onto the display unit, the input unit outputs the phasic operation command and the central processing unit recognizes the phase of the phasic operation command and outputs information corresponding to the recognized phase to the display unit. Without giving a screen switching command plural times, information correlated with information currently displayed on the screen can be effectively displayed on the display screen.

### CROSS-REFERENCE TO RELATED APPLICATIONS

This application is a national stage of International Application No. PCT/KR2012/010021, filed Nov. 26, 2012, which claims the benefit of Korean Application No. 10-2011-0123360, filed Nov. 24, 2011 and Korean Application No. 10-2012-0010491, filed Feb. 1, 2012, in the Korean Intellectual Property Office. All disclosures of the documents named above are incorporated herein by reference.

### BACKGROUND OF THE INVENTION

1. Field of the Invention

The present invention relates to phasic providing of information, and more particularly, to a system in which a phasic operation command is input onto a display unit through the use of various input units and details of information corresponding to the phasic operation command are provided by phases.

2. Description of the Related Art

A touch screen or a touch panel means a user interface that detects a touched position when a text or a specific position on a screen is directly touched with a finger or arbitrary operation means without using a keyboard and that performs an operation corresponding to the touched position through the use of stored software. Examples of the touch panel include a resistive overlay type, a surface acoustic wave type, a capacitive overlay type, and an infrared beam type.

A desired operation command can be directly executed on a display using such types of touch panels. Such touch panels are actually employed as an input unit of a personal portable terminal (such as a smart phone, a PDA, an MP3, and a mobile phone) or a tablet PC.

In a terminal, a lot of types of information are correlated with each other. However, a specific method of effectively displaying information correlated with information currently displayed on the screen is not proposed yet.

In the related art, information correlated with the information currently displayed on the screen is displayed by clicking. However, when the number of phases of the information correlated with the information currently displayed on the screen is one or more, the information pieces are not effectively provided.

U.S. Pat. No. 6,639,584 discloses a method of inputting a control command by movement on a display screen, but does not disclose a specific method of inputting a control command onto a display so as to control a degree of detail by which information is displayed or providing an amount of information to be displayed by phases.

U.S. Pat. No. 7,657,849 discloses a method of providing a lock function through an input unit on a display unit.

Therefore, a method of phasically providing information and rapidly displaying desired information on a screen is required for using contents.

### CITATION LIST

### Patent Literature

PTL 1: U.S. Pat. No. 6,639,584 (Oct. 28, 2003)
PTL 2: U.S. Pat. No. 7,657,849 (Feb. 2, 2010)

### SUMMARY OF THE INVENTION

### Technical Problem

The present invention is made to solve the above-mentioned problem and an object thereof is to provide system and method of phasically displaying or providing details of information or information correlated with the details of information and stored in another storage device in response to a phasic operation command input onto a display unit through an input unit.

### Solution to Problem

In order to achieve the above-mentioned object, according to an aspect of the present invention, there is provided a phasic information providing system and method in a terminal including a display unit, a central processing unit, and an input unit, wherein when a phasic operation command having a specific phase is input onto the display unit, the input unit outputs the phasic operation command, and wherein the central processing unit recognizes the phase of the phasic operation command and outputs information corresponding to the recognized phase to the display unit.

When a point is selected on the display unit, the point moves, and information on the moving distance is output, the central processing unit determines the moving distance to be a phase. When a point is selected on the display unit, the point rotates, and information on the rotational movement is output, the central processing unit determines the angle of the rotational movement to be a phase.

The phase includes + moving phases and − moving phases. When two points are selected through the use of the input unit, the phase is determined with a variation in a distance between the two points.

According to another aspect of the present invention, there is provided a phasic information providing system and method in a terminal including a display unit, a central processing unit, and an input unit, wherein the terminal is connected to a server including a database and a control unit, wherein when a phasic operation command having different phases is input onto the display unit, the input unit outputs the phasic operation command and the central processing unit recognizes the phase of the phasic operation command and outputs information corresponding to the recognized phase to the display unit, wherein the central processing unit transmits information on the phase of the phasic operation command to the server or transmits a phasic operation command signal from the input unit to the server, and wherein the server transmits the information on the phase from the database to the terminal.

When a point is selected on the display unit, the point moves, and information on the moving distance is output, the central processing unit determines the moving distance to be a phase. When a point is selected on the display unit, the point rotates, and information on the rotational movement is output, the central processing unit determines the angle of the rotational movement to be a phase.

The phase includes + moving phases and − moving phases.

On the other hand, when two points are selected through the use of the input unit, the phase is determined with a variation in a distance between the two points.

When a current phase is N and the point moves by +J phases, a finally-selected phase is N+J. When a current phase is N and the point moves by −I phases, a finally-selected phase is N−I.

### Advantageous Effects

According to the aspects of the present invention, it is possible to provide information by phases when a phasic operation command is input onto the display unit through the input unit with a finger or operation means, to provide plural phases of information on the same screen without switching the screen, and to provide information stored in another Internet site or at another storage position.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a configuration of a terminal connected to a server via the Internet.

FIG. 2 is a block diagram schematically illustrating a configuration of the server.

FIG. 3 is a block diagram schematically illustrating a configuration of the terminal.

FIG. 4 is a diagram schematically illustrating an input unit.

FIG. 5 is a diagram illustrating an example where a phasic operation command is input via the input unit.

FIG. 6 is a diagram illustrating an example of a phasic operation command.

FIG. 7 is a diagram illustrating another example of the phasic operation command input via the input unit.

FIGS. 8 and 9 are diagrams illustrating phases of the operation command illustrated in FIG. 7.

FIG. 10 is a diagram illustrating an example where overall information displayed on a screen is changed with a phasic operation command.

FIG. 11 is a diagram illustrating an example where partial information displayed on the screen is changed with a phasic operation command.

FIGS. 12 to 14 are flowcharts illustrating a phasic information providing method according to the present invention.

FIGS. 15 to 17 are diagrams illustrating examples where phasic operation commands are executed.

FIG. 19 is a diagram illustrating an example of a phasic input method.

FIGS. 20 to 28 are diagrams illustrating examples where the size of a selection area is changed.

FIGS. 29 and 31 are diagrams illustrating examples where the details and the size of displayed information are changed.

FIGS. 32 to 34 are diagrams illustrating examples where two or more selection areas are present on the screen.

FIG. 35 is a diagram illustrating examples of phasic operation commands.

FIG. 36 is a flowchart illustrating an example of a method of executing a phasic operation command.

FIG. 37 is a flowchart illustrating an example of a method of causing the server to provide information linked to phases.

### DETAILED DESCRIPTION OF THE EMBODIMENTS

Hereinafter, embodiments of the present invention will be described in detail with reference to the accompanying drawings. The configurations and operational advantages of the present invention will be apparently understood from the following description.

Specific description of known technical configurations may not be described.

The present invention relates to input of a phasic operation command onto a display through an input unit. When a terminal user inputs a “phasic operation command” through the use of the input unit, the phasic operation command is executed by phases.

### Embodiment 1

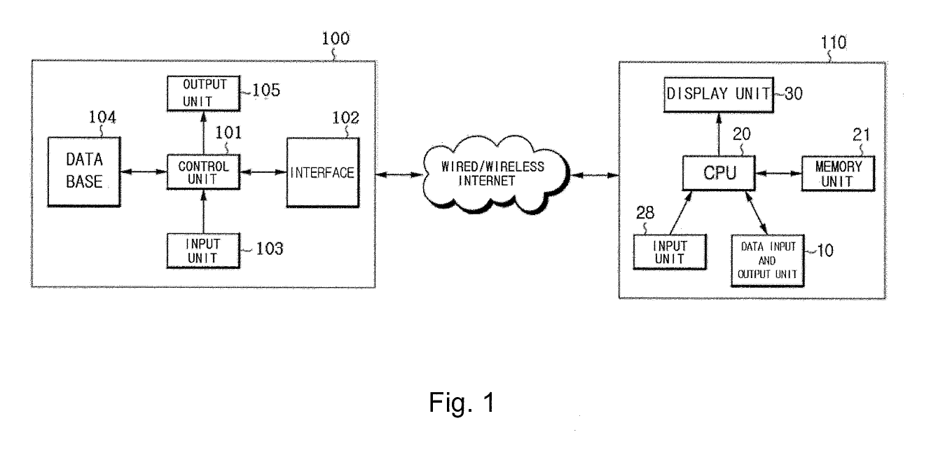

FIG. 1 is a diagram illustrating a configuration of a terminal connected to a server via the Internet.

A server 100 in a communication system is a device constituting a system for managing various information providing services through the use of wired/wireless Internet. The server 100 includes an input unit 103 to which information is input by a manager or an operator, an output unit 105 that outputs or displays information, a database unit 104 that stores a variety of information such as information on service managements, and an interface unit 102 that transmits and receives data to and from a user via a communication network. Here, information includes images, videos, and texts.

A terminal (or computer) 110 is a device that transmits and receives a variety of information via the wired/wireless Internet (or communication network).

The terminal 110 includes a central processing unit (CPU) 20, a display unit 30 that displays a variety of information, a memory unit 21 that stores a variety of information, an input unit 28 that inputs information, and a data input and output unit 10 that inputs and outputs information or data.

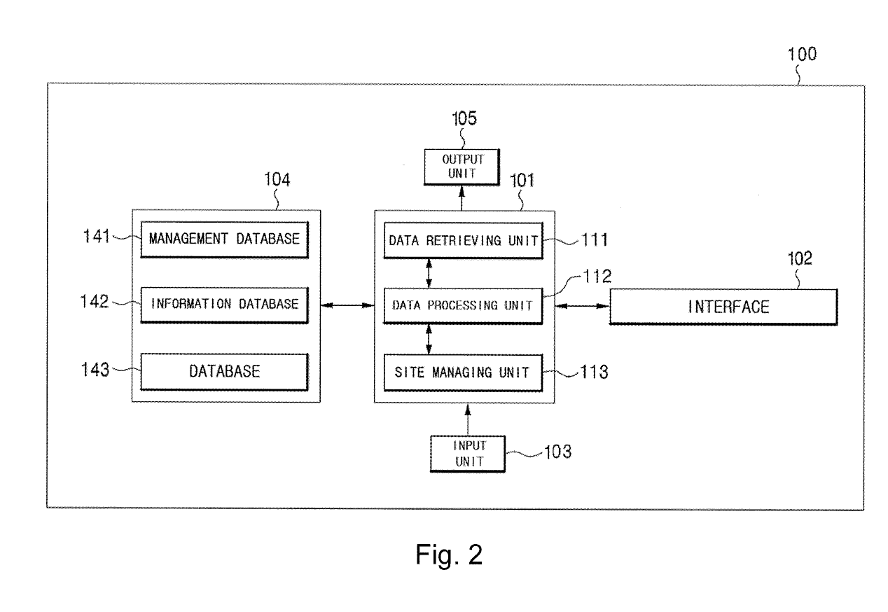

FIG. 2 is a block diagram illustrating a detailed configuration of the server.

The server 100 includes a control unit 101. The control unit 101 includes a data retrieving unit 111 that retrieves data, a data processing unit 112, a site managing unit 113 that manages Internet users or Internet members.

The database unit 104 of the server 100 includes a management database 141 that stores information relevant to site management, an information database 142, and a database 143.

The control unit 101 and the database unit 104 are examples and may employ a general control unit and a general database.

In the control unit 101 of the server 100, the site managing unit 113 manages user (or terminal) information, member information, and information on use of contents, and the data retrieving unit 111 retrieves data corresponding to information transmitted from a user (or terminal) from the database unit 14, and the data processing unit 112 transmits retrieved data to the user via the interface.

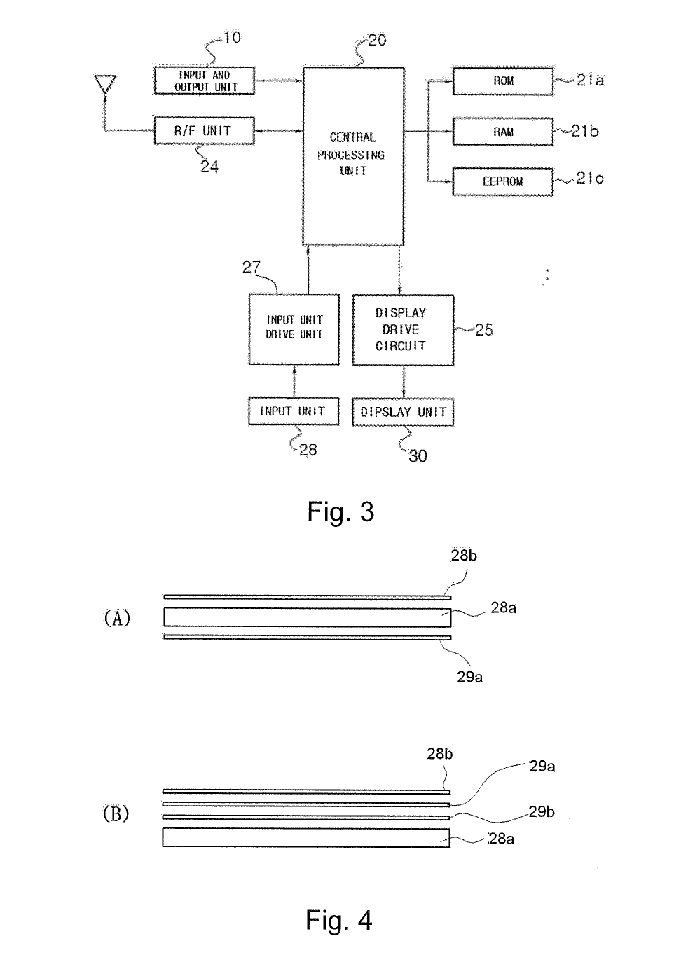

FIG. 3 is a block diagram illustrating a configuration of a terminal.

The central processing unit 20 is control means for controlling the overall operations of the terminal (for example, a portable display, a smart phone, or a computer) used in the present invention. A ROM 21a in the memory unit 21 controls stores display driving programs, a RAM 21b stores data required for executing the programs, and an EEPROM 21c stores data required by a user and data required for processing the data.

A radio frequency (RF) unit 24 amplifies various signals in tune with RF channels and converts RF signals received via an antenna into frequency signals. The input and output unit 10 includes an input and an output unit. The input unit includes various information input devices, ten keys, a menu key, and a selection key. The output unit includes a speaker or a vibrator.

The terminal further includes a display drive circuit 25 that drives a display in response to a control signal and that outputs a signal for driving the display 30.

The central processing unit controls the input unit 28 through the use of an input unit drive unit 27. That is, when information is input via the input unit, the input unit drive unit outputs and transmits the input information to the central processing unit.

The terminal used in the present invention may be a portable display, a smart phone, a tablet PC, or a computer.

FIG. 4 is a diagram illustrating the input unit.

FIG. 4(A) is a cross-sectional view illustrating a capacitive type and FIG. 4(B) is a cross-sectional view illustrating a resistive type.

As illustrated in FIG. 4(A), an electrode plate 29a coated with a transparent electrode is disposed below a protective plate 28a, and the electrode plate 29a has a structure in which one or more films coated with a transparent electrode are stacked.

In FIG. 4(B), two films 29a and 29b coated with a transparent electrode are stacked with a constant gap interposed therebetween on a protective plate 28a. An external protective plate (or a decorative film) 28b may be further formed on the input units 28 and 28. The protective plate 28b is coated with a desired pattern.

The input units 28 illustrated in FIG. 4 are examples that are normally used and the input units 28 do not limit the present invention. General input units 28 that are disposed on a display to input information can be used in the present invention.

Here, the input of information on the display also means that information may be input without pressing or touching the surface of the display.

The present invention can also be applied to a input device which are integrated a display device.

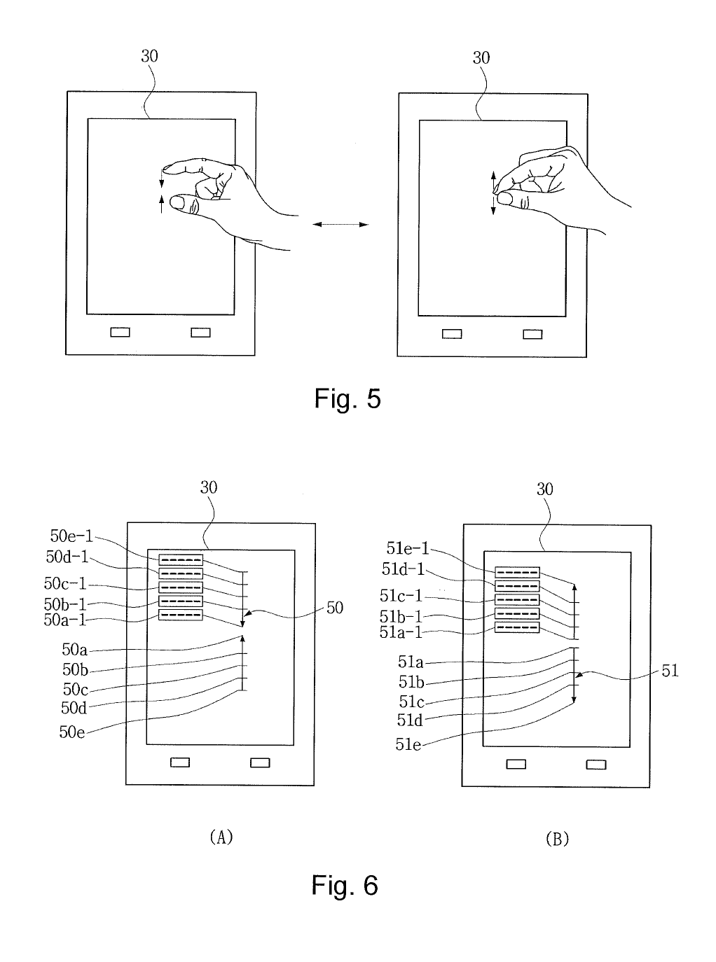

FIG. 5 is a diagram illustrating an example where a phasic operation command is input via the input unit.

As illustrated in FIG. 5, a phasic operation command is input to the display 30 using a small bar or a finger.

That is, a phasic operation command is input on information displayed on the display via the input unit 28. As illustrated in FIG. 5, the phasic operation command is input by increasing or decreasing a distance between points selected with two fingers.

FIG. 6 is a diagram illustrating an example where a phasic operation command is executed.

A “phasic operation command” is executed by selecting two points with two fingers (or two bars), dividing a moving distance determined by movement of the two points into phases, and recognizing the phases. When the phasic operation command is executed, information corresponding to the respective phases is displayed on the screen of the display 30. The moving distance can be divided into N phases where N is two or more. The value of N preferably ranges from 5 to 10.

The phases can be defined as follows.

1) A distance recognized by one phase is determined in advance.

2) The maximum number of phases recognizable is determined in advance.

3) The phasic operation command includes a + direction and a − direction.

4) There is an error range.

5) Information corresponding to each phase is present by phases.

Referring to FIG. 6, guide lines 50 and 51 guiding movement between points are displayed and phases 50a, 50b, 50c, 50d, and 50e are marked on the guide lines in FIG. 6(A), respectively (phases are denoted by 51a, 51b, 51c, 51d, and 51e in FIG. 5(B)).

In FIG. 6(A) in which the distance between two points decreases, a first phase, a second phase, a third phase, a fourth phase, and a fifth phase are denoted by “50e”, “50d”, “50c”, “50b”, and “50a”, respectively.

In FIG. 6(B) in which the distance between two points increases, a first phase, a second phase, a third phase, a fourth phase, and a fifth phase are denoted by “51a”, “51b”, “51c”, “51d”, and “51e”, respectively.

When the moving distance by one phase is defined as 10 mm, movement of 20 mm corresponds to movement of two phases. Since total five phases are present, the maximum moving distance is 50 mm.

The distances between the phases do not need to be constant. For example, the distance between the first phase and the second phase may be set to 10 mm and the distance between the second phase and the third phase may be set to 12 mm. The distances between phases have only to be determined in advance.

The inter-phase distance may be variable at the time of execution of algorithms of a program. For example, the distance between the first and second phases is 10 mm, but may be changed to 12 mm by an algorithm before inputting the phasic operation command.

That is, when a phasic operation command is input via the input unit, the operation command is phasically recognized and a phasic operation command is recognized as movement of N phases.

The phasic operation command is input in the + direction and the − direction.

For example, the phasic operation command is movement in the − direction when two points selected using the input unit get close to each other, and is movement in the + direction when the two points are separated away from each other (vice versa).

Accordingly, when movement of 20 mm is carried out as illustrated in FIG. 6(A) and the moving distance between neighboring phases is 10 mm, it means movement of two phases in the − direction. When movement of 20 mm is carried out as illustrated in FIG. 6(B) and the moving distance between neighboring phases is 10 mm, it means movement of two phases in the + direction.

As described above in 4), the phasic operation command has an error range. Movement of 13 mm can be determined to be movement of one phase and movement of 18 mm can be determined to be movement of two phases. The error range may be determined in the same way as round-up and round-down in mathematics.

When it is intended to input a phasic operation command, guide lines 50 and 51 having scales marked by phases may be displayed on the screen of the display 30 as illustrated in FIG. 6.

When a user of the terminal 110 selects a phasic operation command (various selection methods may be used depending on program environments and will not be particularly mentioned), the guide lines 50 and 51 are displayed on the display screen. The user can accurately input the phasic operation command using the guide lines.

When the guide lines are actually displayed on the screen, numerals corresponding to the phases are displayed on the screen.

In another example, simple items of information corresponding to the respective phases as well as the numerals of the phases may be displayed to correspond to the guide lines 50 and 51.

As described above in 5), information corresponding to the phases is present. Accordingly, when the phasic operation command is input, the finally-selected phase is determined and information corresponding to the finally-selected phase is provided. The information corresponding to the finally-selected phase is displayed on the display screen.

In FIG. 6, the information corresponding to the respective phases is “(50a-1), (50b-1), (50c-1), (50d-1), and (50e-1)” and “(51a-1), (51b-1), (51c-1), (51d-1), and (51e-1)”.

In FIG. 6(A), information corresponding to the first phase “50e” is “50e-1”. In FIG. 6(B), information corresponding to the first phase “51a” is “51a-1”.

Therefore, when the information corresponding to the first phase “50e” in FIG. 6(A) is “location of mobile phone agency”, a text (an image in some cases) “location of mobile phone agency” is actually displayed in a box indicated by “50e-1” on the screen of FIG. 6(A).

When the information corresponding to the first phase “51a” in FIG. 6(B) is “specifications of mobile phone”, a text (an image in some cases) “location of mobile phone agency” is actually displayed in a box indicated by “51a-1” on the screen of FIG. 6(B).

FIGS. 6(A) and 6(B) are separately described to distinguish the + direction and the − direction, but when FIGS. 6(A) and 6(B) are displayed on the same screen, the first phase may be “50a” and “51a” and the fifth phase may be “50e” and “51e”.

Therefore, regarding the phasic information, the information “50a-1” corresponding to the first phase in FIG. 6(A) and the information “51a-1” corresponding to the first phase in FIG. 6(B) are equal to each other. Similarly, the information “50e-1” corresponding to the fifth phase in FIG. 6(A) and the information “51e-1” corresponding to the fifth phase in FIG. 6(B) are equal to each other.

### Embodiment 2

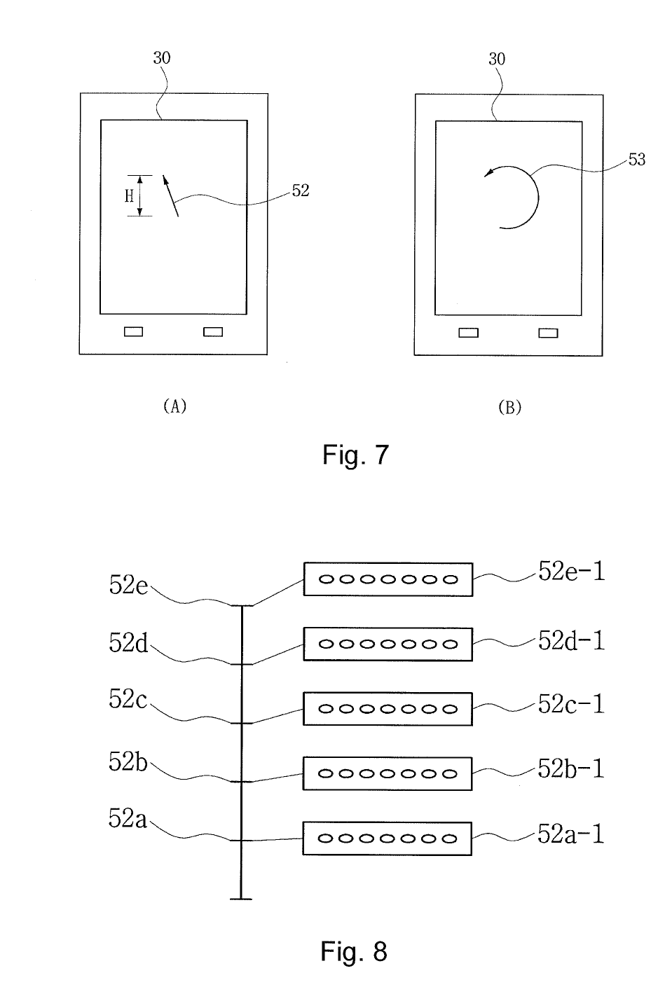

FIG. 7 is a diagram illustrating another example of the phasic operation command input through the input unit.

FIG. 7(A) is a diagram illustrating movement of one point selected with a finger or a bar using the input unit and FIG. 7(B) is a diagram illustrating a moving angle. A + direction may be defined when the point moves upward or rotates in the counterclockwise direction, and vice versa.

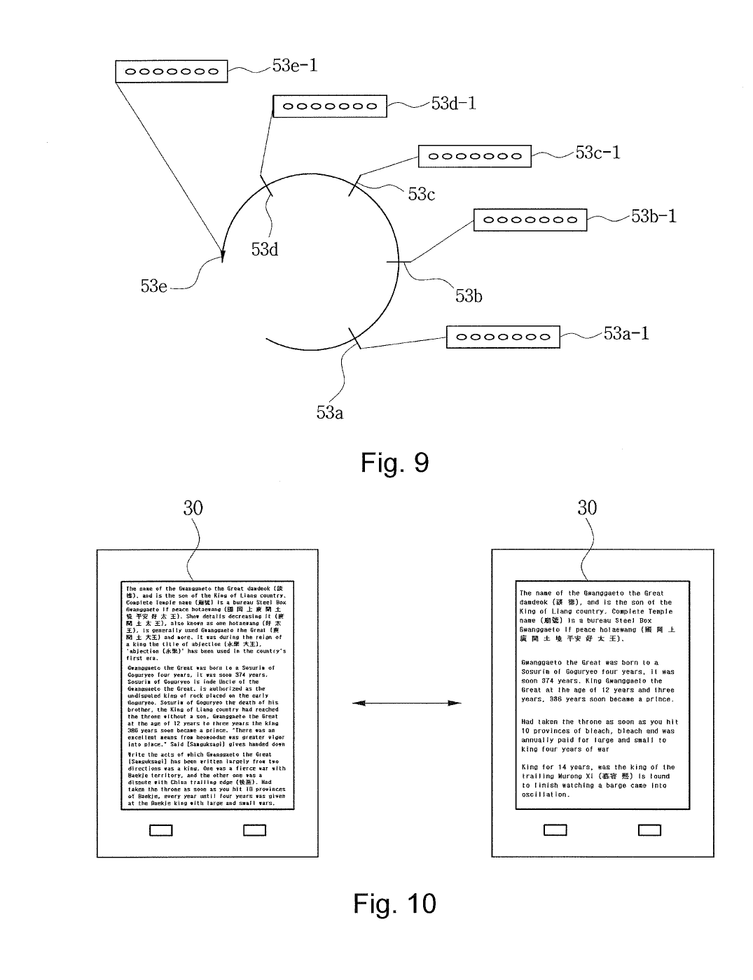

FIGS. 8 and 9 are diagrams illustrating phases of the operation command in FIG. 7.

FIG. 8 corresponds to FIG. 7(A). A moving distance is divided into phases and features (information details) of information corresponding to the respective phase are displayed on the screen. For example, a first phase is denoted by “52a” and a second phase is denoted by “52b”. Information corresponding to the first phase is denoted by “52a-1” and information corresponding to the second phase is denoted by “52b-1”. Accordingly, numerals indicating the phases and features of the information corresponding to the phases can be displayed on the screen of the display 30.

FIG. 9 corresponds to FIG. 7(B). A moving angle is divided into phases and features (information details) of information corresponding to the respective phase are displayed on the screen. For example, a first phase is denoted by “53a” and a second phase is denoted by “53b”.

The phasic operation command can be executed as follows.

1) When a point is selected using the input unit 28 of the terminal (with a finger or a bar), the input unit drive unit 27 outputs position information (coordinates) of the selected point. When the point moves, the input unit drive unit 27 outputs position information (coordinates) of the moved point.

2) The central processing unit 20 determines moving phases from the position information of the point using a predetermined algorithm and reflects the moving phases to the initial phase (addition for + movement and subtraction for − movement) to determine the finally-selected phase.

3) When the finally-selected phase is determined, the central processing unit 20 selects information corresponding to the finally-selected phase from the memory unit 21 and outputs a signal for displaying the information on the display 30.

In this embodiment, a point is selected and a moving distance or a moving angle is divided into phases by a phasic operation command. The phasic operation command can be executed in various ways.

For example, a time in which a point is selected and maintained may be divided into phases.

A degree by which the terminal itself moves may be divided into phases.

Movement on the display may be recognized with an imaging device, a degree of movement is determined on the basis of a signal output from the imaging device, and the degree of movement may be divided into phases. The shape of a finger or the shape of an image may be divided into phases.

When any input to the terminal using any method can be divided into phases like the phasic operation command, information corresponding to the finally-moved phase can be displayed on the display screen.

### Embodiment 3

FIG. 10 is a diagram illustrating an example where display information of the entire screen is changed in response to a phasic operation command.

In FIG. 10, a degree of detail of information is divided into phases. When information is displayed at a first degree of detail in the left part of the drawing, the screen display of the left part can be switched to another phase by the phasic operation command described above.

For example, when an operation command with a second degree of detail is input, information with a third degree of detail is displayed on the screen of the display 30. The degree of detail of information may increase in the ascending order of the degrees, or may decrease in the ascending order of the degrees.

The change in the degree of detail by phases means that the same type of information is sorted by the degrees of detail of information by phases. The initial phase corresponds to abstracts and the degree of detail of explanation increases with an increase in phases.

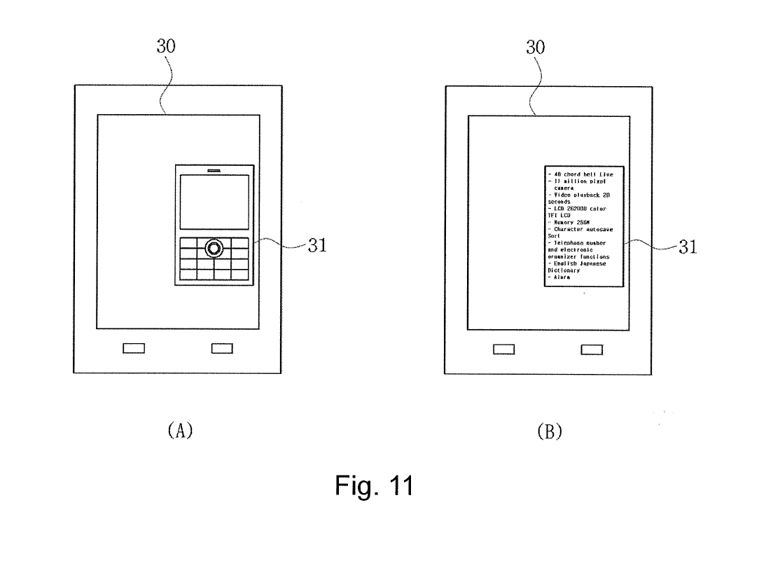

FIG. 11 is a diagram illustrating an example where some display information on the screen is changed with a phasic operation command.

A selection area 31 in which a phasic operation command can be input is present in a part of the screen. Accordingly, a terminal user first selects the selection area (a point in the selection area can be selected on the display by the user. Various selection methods can be used depending on the types of a program).

When the selection area 31 is selected, the central processing unit determines that the selection area 31 is selected on the basis of a signal on the position information output from the input unit.

When a phasic operation command is input to the selection area 31, the central processing unit displays information corresponding to the finally-selected phase on the display screen on the basis of the method described in this embodiment.

When the finally-selected phase is changed, the size of the selection area may be changed depending on the information to be displayed.

1) The size of the selection area is not changed.

2) The size of the selection area increases in proportion to an increase in phase.

3) The size of the selection area is changed depending on types of information.

### Embodiment 4

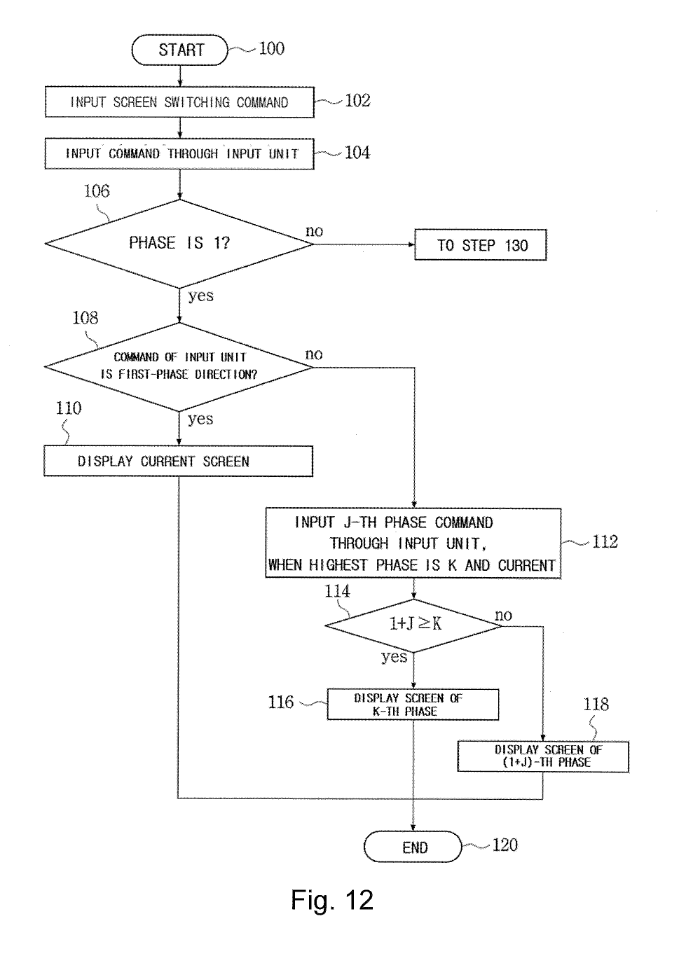

FIGS. 12 to 14 are flowcharts illustrating a phasic information providing method according to the present invention.

The process flow of the phasic information providing method is illustrated in the drawings. That is, when a phasic operation command is input using the input unit 28 as described above, information is displayed on the display.

This function may be performed by the control unit 101 of the server 100 or may be performed by the control unit 20 of a terminal.

A terminal 110 may access the server via a wired/wireless Internet or a communication network and may perform the above-mentioned method. When a phasic operation command is input using the input unit 28 of the terminal 110, the input information is transmitted to the server via the communication network. The server selects information corresponding to the phase of the operation command from the database and transmits the selected information to the terminal. The terminal displays the transmitted information on the screen of the display 30.

In the present invention, all the known wired and wireless communication methods can be used.

Information corresponding to a phasic operation command can be displayed on the display screen using the central processing unit 20 and the memory unit 21 of the terminal.

The access to the server and the execution of algorithms in the terminal can be determined time to time depending on the types of corresponding programs and information. This determination may be performed by a program or by selection of a user.

In order to switch the screen to correspond to the phase of a phasic operation command, information corresponding to the phases of the phasic operation command is stored in the database of the server or the memory unit of the terminal.

For example, when a volume of Birth of King Gwanggaeto is defined as a unit content, information relevant to the volume of Birth of King Gwanggaeto is divided into five phases (when the number of phases is five) depending on the degree of detail and is stored.

When the information of the “volume of Birth of King Gwanggaeto” is “HiKaKi001”, information “HiKaKi001-01” corresponding to the first phase which is most detailed, information “HiKaKi001-02” corresponding to the second phase, and information “HiKaKi001-05” corresponding to the fifth phase which is most brief are stored. When a phase is selected by a phasic operation command, information corresponding to the selected phase is displayed on the display screen.

As illustrated in FIG. 12, first, a screen switching command is input (S102). The screen switching command in the present invention is a command for selecting a phase before a user inputs a phasic operation command. By this selection, the central processing unit of the terminal is switched to a state where it can recognize the phasic operation command.

This selection may be performed using a menu button or by pressing the screen for a predetermined time. The step of the screen switching command may be skipped in some cases. By only displaying information that can be subjected to the phasic operation command on the display screen, the central processing unit (or the control unit) is switched to a state where it can recognize a phasic operation command.

Then, a phasic operation command (an operation command having different phases) is input using the input unit (S104).

It is determined whether the current phase is a first phase (S106). When it is determined that the current phase is not the first phase, the process of “S130” is performed.

It is determined whether the movement direction of the phasic operation command is the + direction or the − direction. The phase ranges from the first phase to the K-th phase.

Then, it is determined whether the movement direction is the first direction (movement in the − direction) (S108).

When it is determined that the movement direction is the first direction, the current screen state is displayed as it were (S110).

When it is determined that the movement direction is not the first direction (that is, the movement direction is the + direction), assumptions are made as follows.

When the phase of the phasic operation command ranges from the first phase to the K-th phase, the lowest phase is the first phase and the highest phase is the K-th phase. It is assumed that the phase input using the input unit is the J-th phase (S112).

When “1+J≧K” is satisfied, the screen of the K-th phase is displayed. Otherwise, the screen of the “(1+J)-th” phase is displayed (steps S114 to S118).

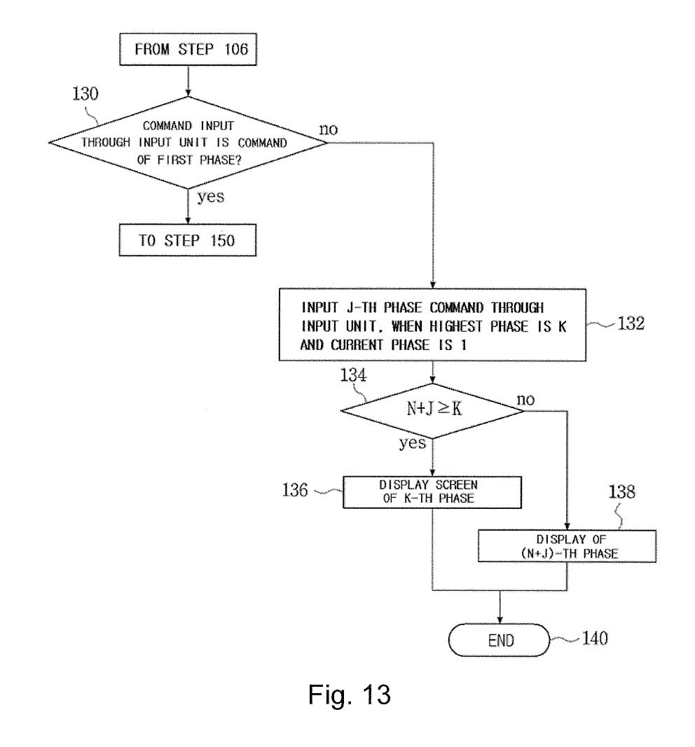

FIG. 13 is a flowchart illustrating a case where the phase currently displayed on the screen is not the first phase.

When the direction of the phasic operation command is the first direction, the process of step S150 is performed.

When the direction of the phasic operation command is not the first direction, it is assumed that the phase currently displayed on the screen is the N-th phase. The phase of the phasic operation command ranges from the first phase to the K-th phase, the lowest phase is the first phase, and the highest phase is the K-th phase. At this time, it is assumed that the input phase is the J-th phase (S132).

When “N+J≧K” is satisfied, the screen of the K-th phase is displayed. Otherwise, the screen of the (N+J)-th phase is displayed (steps S134 to S138). Thereafter, the process flow ends in response to an ending command (S140).

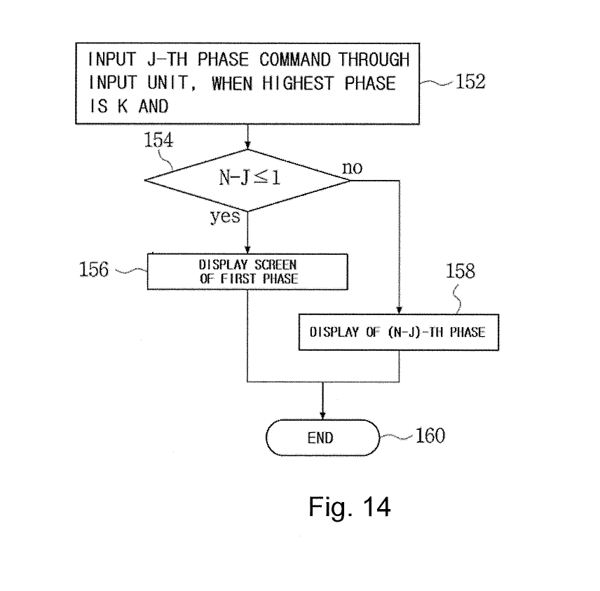

FIG. 14 is a flowchart illustrating a case where the input direction in step S130 of FIG. 13 is the first direction.

Similarly, it is assumed that the phase currently displayed on the screen is the N-th phase. The phase of the phasic operation command ranges from the first phase to the K-th phase, the lowest phase is the first phase and the highest phase is the K-th phase. At this time, it is assumed that the input phase is the J-th phase (S150). When “N−J≦1” is satisfied, the screen of the first phase is displayed. Otherwise, the screen of the (N−J)-th phase is displayed (steps S152 to S158). Thereafter, the process flow ends in response to an ending command (S160).

The above-mentioned process flow is performed by the central processing unit (CPU) 20 of the terminal or the control unit 101 of the server.

### Embodiment 5

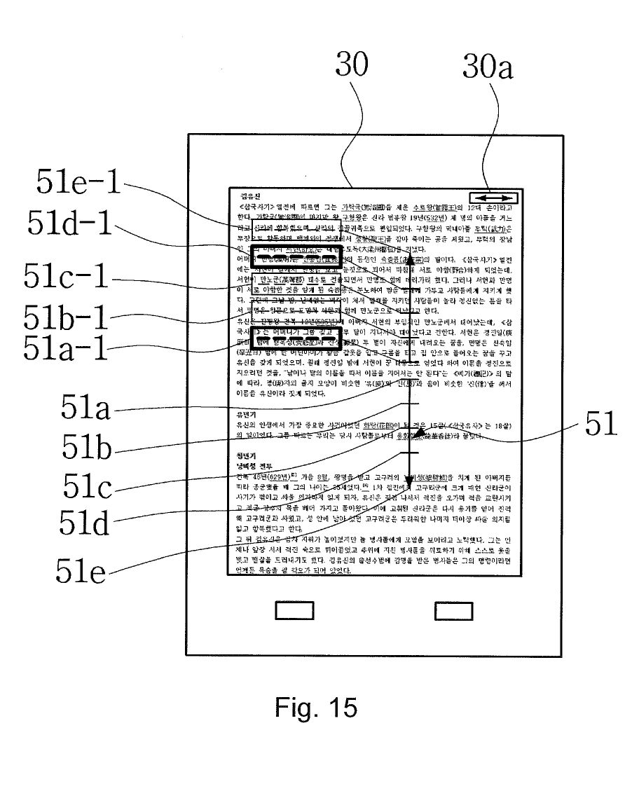

FIGS. 15 to 17 are diagrams illustrating another example where a phasic operation command is input and executed.

When the screen switching command 30a is selected and the phasic operation command is input on the display 30 using the input unit, operation command guide lines 51 are displayed on the screen of the display 30.

Phases (first phase, second phase, and the like are displayed as numbers) 51a to 51e like scales are displayed in the operation command guide lines 51 so as to effectively execute the phasic operation command by movement in the displayed scales. When movement of two phases is desired, the movement can be realized while viewing the scales displayed on the screen.

Features or details of information corresponding to the respective phases are also displayed. Information display boxes 51a-1 to 51e-1 linked to the respective phases appear, and details of the information corresponding to the respective phases are displayed as texts, or images, or linkage sites in the respective information display boxes 51a-1 to 51e-1.

In order to easily input a phasic operation command, the display box indicating the current phase can be displayed to be distinguished from other display boxes (in colors or gray scales).

When a phasic operation command is input, the guide lines 51 appear and the display box (a display window 51a-1 when the current phase is the first phase) corresponding to the current phase can be displayed darker than the other display boxes.

When movement of three phases is input, the display box (the display box 51d-1 of the fourth-phase when the current phase is the first phase and movement of three phases is performed) corresponding to the final phase can be displayed darker (or distinctly) than the other display boxes. When the movement is performed in the opposite direction, the current display box and the final display box can be displayed so as to be distinct fro the other display boxes.

When the display box is not displayed on the screen, the current phase and the final phase can be displayed to be distinct from the other phases using the scales indicating the phases of the guide lines. That is, the scale of the corresponding phase in the guide lines can be displayed to be distinct from the scales of the other phases.

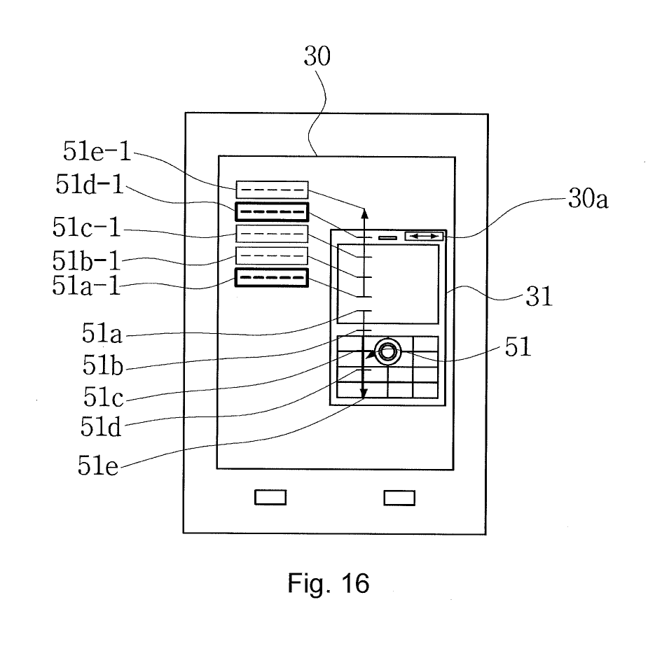

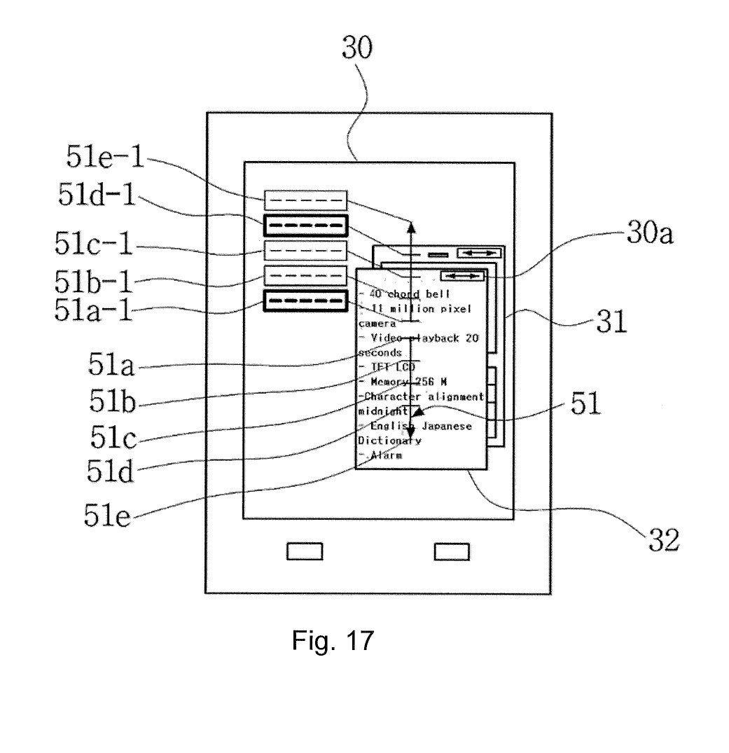

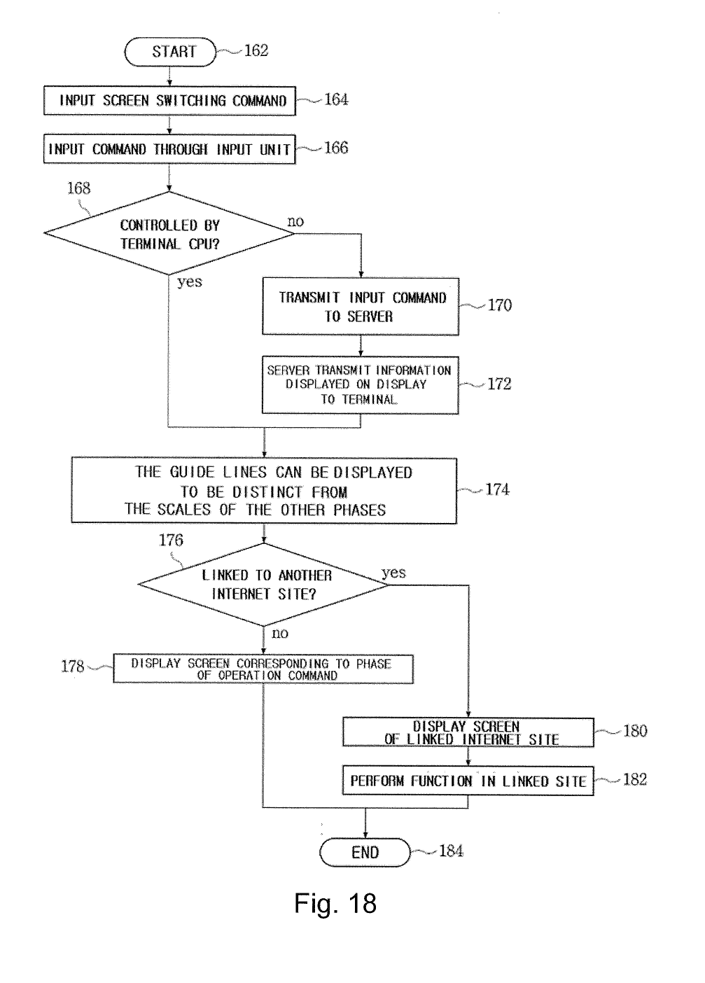

FIGS. 16 and 17 are diagrams illustrating an example where a particular selection area 31 is present on the screen. When the screen switching command 30a is selected (for example, by selecting the displayed part 30a) and a phasic operation command is input, the guide lines 51 are displayed, phases 51a to 51e marked with scales are displayed in the guide lines 51, display boxes 51a-1 to 51e-1 connected to the respective phases are displayed, and features of information are displayed in the respective boxes.

When the information displayed in the selection area 31 in FIG. 16 is information of the first phase and information displayed in a new selection area 32 in FIG. 17 is information of the fourth phase, the screen of FIG. 17 is displayed by inputting a phasic operation command to the selection area 31 on the screen of FIG. 16 and performing movement of three phases.

The display box 51a-1 of the current phase and the display box 51d-1 of the final phase are displayed to be distinct from the other display boxes.

In this example, “image of mobile phone” is displayed in the display box 51a-1 of the first phase and “specifications of mobile phone” is displayed in the display box 51d-1 of the final phase.

When the fifth phase is a phase linked to another Internet site, “linked to OOO site” is displayed in the display box 51e-1 of the fifth phase. When the fifth phase is selected, information of the linked Internet site is newly displayed on the screen of the display 30. Accordingly, a subsequent job such as purchase of a product can be progressed in the newly-linked Internet site.

On the other hand, in this embodiment, information displayed on the display screen can be changed with a change in phase as follows.

1) An amount of information displayed on the display screen increases with an increase in phase order. The degree of detail of information also increases.

2) Contents of information displayed on the display screen are changed with a change in phase (the degree of detail may not increase).

3) A program executed to display information on the display screen is changed with a change in phase. For example, image information or video information may be displayed with a change in phase.

4) The layer of information displayed on the display screen may be changed with a change in phase.

For example, the first phase corresponds to an image of an exterior of an automobile, the second phase corresponds to an image of components of the automobile from which the exterior is removed, and the third phase corresponds to an inside image of the components. That is, with a change in phase, the information displayed on the display screen can be changed from the exterior to the interior.

5) Information stored in a separate storage device or a separated storage position can be displayed on the display screen with a change in phase.

6) Linkage to another Internet site can be carried out with a change in phase.

7) When a selection area capable of being subjected to a phasic operation command is separately present on the screen, the size of the selection area increases with an increase in phase order. The size of the selection area may decrease or may not be changed depending on the information displayed on the display screen.

FIG. 18 is a flowchart illustrating an example where an operation command is input and executed using the guide lines.

When a phasic operation command is input, guide lines 50 and 51 are displayed on the screen, scales are displayed in the guide lines 50 and 51, and thus a control command can be more accurately executed by causing the user to input the phasic operation command while viewing the scales. FIG. 18 illustrates this example.

When a program is executed, a terminal user inputs the screen switching command (S164) and then inputs the phasic operation command using the input unit (S166).

The screen switching command (30a in FIG. 6) is not limited to the examples of the present invention. The screen switching command can be input by a clicking operation for a predetermined time, a particular moving operation, a display of a particular menu on the screen, pressing of a specific key of a keyboard or a specific button key, input of various commands such as a voice command and a vibration command, and the like.

Then, the phasic operation command is input using the input unit (S166).

When the function of controlling the phasic operation command is performed by the terminal itself, the central processing unit of the terminal displays the guide lines 50 and 51 having phases displayed therein on the display screen.

Also, the server may transmit the guide line display information to the terminal, and the central processing unit of the terminal may display the transmitted information on the display screen. Design of the guide lines or display information is stored in the memory unit of the terminal or the database of the server.

The form in which the guide lines are displayed on the display screen is not limited to the form of the guide lines 50 and 51 described in this example. When a phase and abstract of information corresponding to the phase can be displayed, any form can be used in the present invention.

When the information displayed on the display screen of the terminal is not controlled by the CPU of the terminal but by the control unit of the server connected thereto, the command input using the input unit is transmitted to the server and the server transmits information to be displayed on the display screen of the terminal to the terminal (S168 to S174).

Then, the guide lines and the display boxes are displayed on the display screen.

When the selected phase does not correspond to the linkage to another Internet site, information corresponding to the phasic operation command is displayed on the display screen (S176 to S178).

However, when the selected phase after the operation command is input corresponds to linkage to another Internet site, information of the linked Internet site is displayed on the display screen. Various functions of the linked site are then carried out (S180 to S182).

The functions of the linked Internet site mean all the functions that can be actually carried out over the Internet. For example, a general payment system for selecting and paying for products can be linked.

The function can ends in response to an ending command (S184).

### Embodiment 6

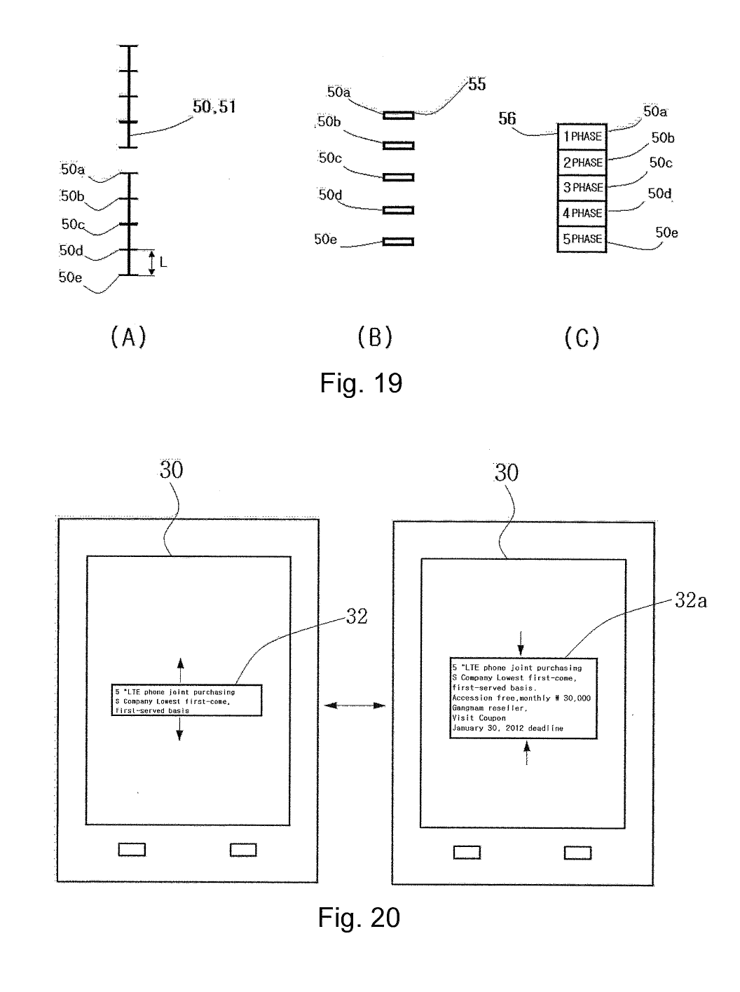

FIG. 19 is a diagram illustrating another example of the phasic operation command inputting method.

FIG. 19(A) illustrates an example where the guide lines 50 and 51 having scales 50a, 50b, 50c, 50d, and 50e marked therein are displayed on the screen of the display 30. The distance L (distance actually displayed on the display screen) between the scale displayed on the display 30 may be substantially equal to the distance by which movement is made at the time of inputting the phasic operation command.

For example, when the distance L is 10 mm, the distance of one phase of the phasic operation command is 10 mm. Accordingly, a user inputting the phasic operation command can display information of a desired phase on the display screen by moving the selected point (using the input unit) by the actual size of the scales of the guide lines 50 and 51 displayed on the display screen.

When a position signal indicating that the selected point moves by the size of the scales is output from the input unit drive unit 27, the central processing unit of the terminal or the control unit of the server selects and displays information corresponding to the output position on the display screen.

FIG. 19(B) illustrates another example where the phases 50a, 50b, 50c, 50d, and 50e are displayed on the screen of the display 30. A shape or figure that can distinguish the phases can be applied to the present invention.

The phasic operation command can be input by moving the selected point by the distance to the phase using the input unit or may be input by selecting a desired phase from the phases displayed on the display screen. In FIG. 19(B), when the current phase is the first phase 50a and it is desired to display information of the fifth phase on the screen, the display bar 55 corresponding to the fifth phase 50e can be selected.

FIG. 19(C) illustrates an example where the phases are displayed in a different form. The phases 50a, 50b, 50c, 50d, and 50e are displayed in the form of boxes.

The shape indicating the phases is not limited to the shapes of this embodiment and the phases can be displayed in various forms.

### Embodiment 7

FIGS. 20 to 28 are diagrams illustrating an example where the size of the selection area is changed.

As illustrated in the drawings, it is assumed that a selection area 32 occupies a part of the screen of the display 30.

When a selection area 32 is selected using the input unit and then a phasic operation command is input, the selection area 32 is changed in size in response to the operation command. Movement in the + direction causes an increase in size and an increase in the amount of information, and movement in the − direction causes a decrease in size and a decrease in the amount of information.

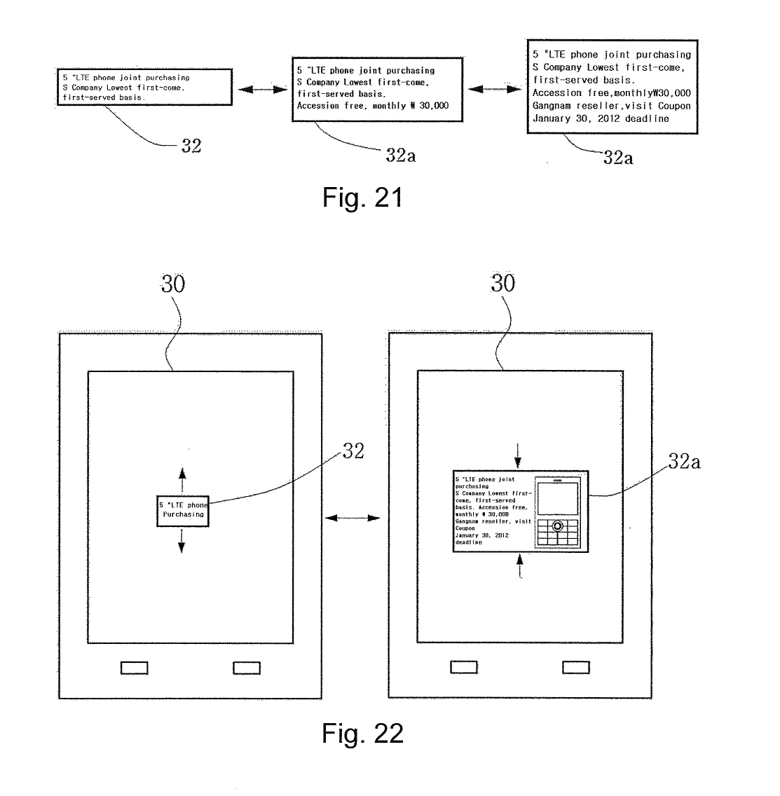

FIG. 21 is a diagram illustrating an example of phases of the information illustrated in FIG. 20. In FIG. 21, the information is divided into three phases for the purpose of convenience, but may be divided into more phases.

As illustrated in the drawing, the selection area 32 have various sizes and various phases, and information corresponding to the size and the phase of the selection area is displayed on the display screen.

In FIGS. 20 and 21, the selection area 32 is vertically changed in size. The size of the selection area can be horizontally changed.

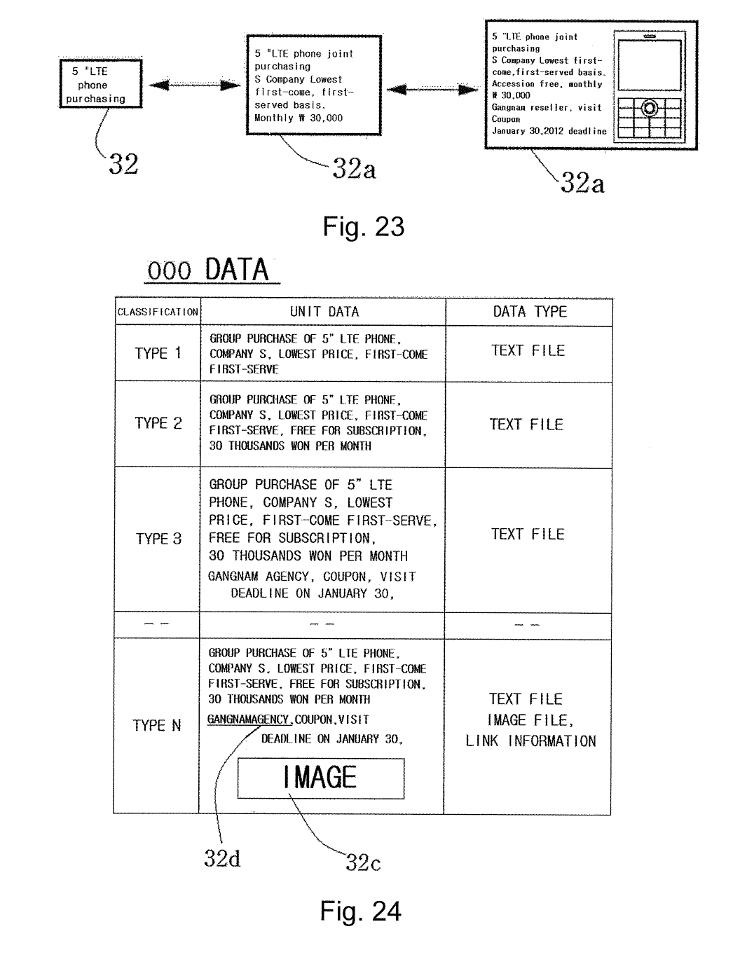

FIGS. 22 and 23 are diagrams illustrating an example where the size of the selection area 32 is changed vertically and horizontally. When the selection area 32 is selected and a phasic operation command for changing the size is input as illustrated in the drawings, the selection area 32 is changed to a new selection area 32a. The size of the selection area is changed by phases.

In FIG. 23, the size is changed in three phases, but the size can be divided into more phases. Information corresponding to the sizes of the selection area is displayed on the display screen. In FIG. 23, text information and image information may be displayed together depending on the phases.

FIG. 24 is a diagram illustrating an example of a format in which information is stored. The size is divided into N phases and information corresponding to the respective sizes is stored. Here, the types correspond to the phases, and when a phase is selected, information corresponding to the selected phase is displayed on the display screen.

The information is stored in the memory unit 21 of the terminal or the database unit 104 of the server. The information may be stored in a separate storage device or a separated server.

The information may include an image file 32c or a video file in addition to a text file. When the corresponding area is clicked, link information 32d linked to another site can also be displayed.

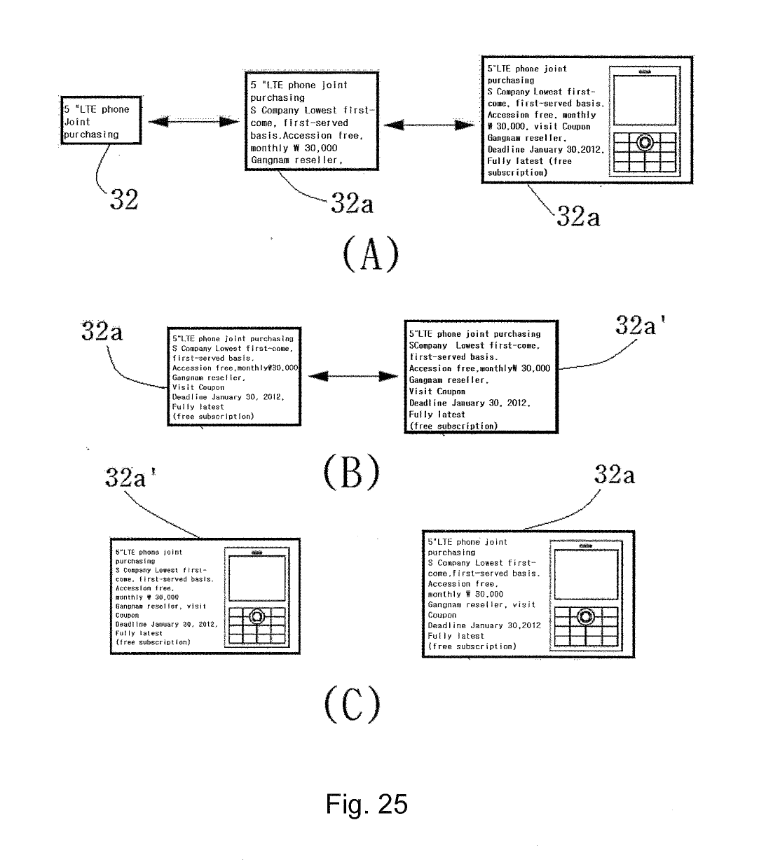

FIG. 25 is a diagram illustrating other examples.

In FIG. 25A, the sizes of the selection areas 32 and 32a are changed depending on the phases and the information displayed in the selection areas 32 and 32a is also changed.

FIGS. 25(B) and 25(C) illustrate examples of a method of selecting a phase depending on the size of the selection area. When the size of the selection area is adjusted using a phasic operation command and the size of the selection area is not equal to the second phase but is close to the second phase as illustrated in FIG. 25(B), the information of the second phase is displayed in the selection area 32a′.

When the size of the selection area is not equal to the third phase but is close to the third phase as illustrated in FIG. 25(C), the information of the third phase is displayed in the selection area 32a′.

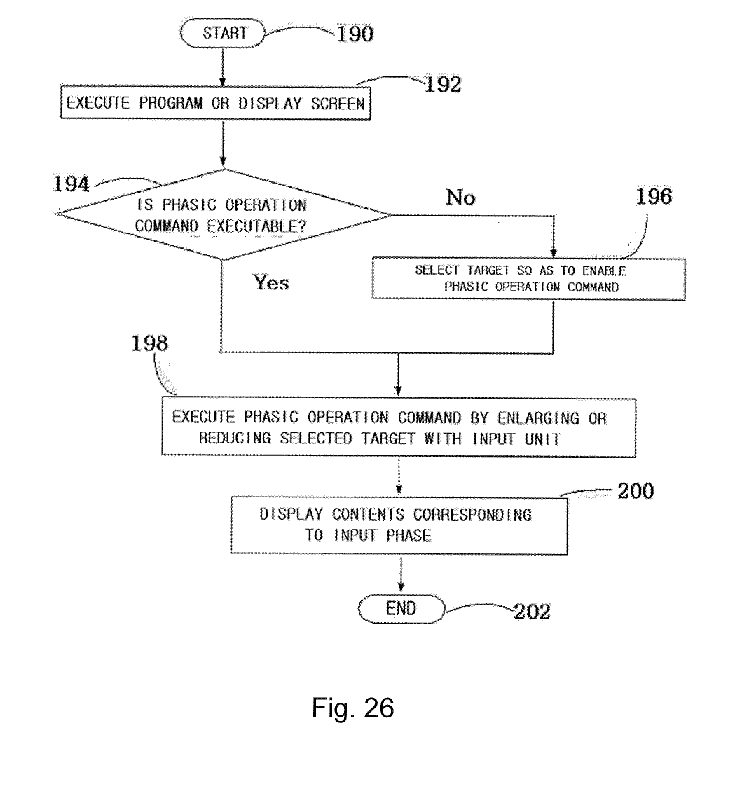

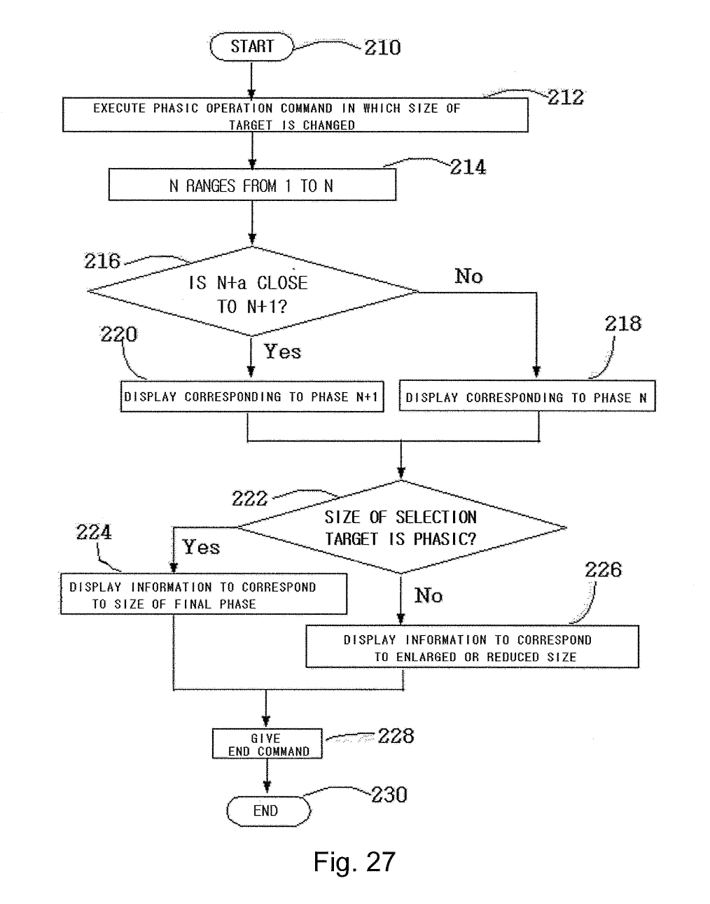

FIGS. 26 and 27 are flowcharts.

A program is executed and a screen is displayed (S190 to S912).

When the input of a phasic operation command is not disabled, the phasic operation command has to be set to be enabled (S194 to S196).

When the input of the phasic operation command is enabled, the selection area 32 is selected from the screen to enable the input of the phasic operation command using the input unit 28, and then the selection area 32a or 32a′ of which the size is changed and information corresponding thereto are displayed on the display screen (S198 to S200). The process flow ends in response to an ending command (S202).

FIG. 27 is a flowchart illustrating an example for smoothly inputting a phasic operation command.

After the program is executed or the screen is displayed, the selection area 32 is selected and an operation command for changing the size thereof is input (S210 to S212).

When it is assumed that there are types 1 to N, the size of the selection area 32 is determined to correspond to types 1 to N (S214). These sizes are stored in the memory unit 21 or the database unit 104.

A user may accurately adjust the size of the selection area 32 to sizes corresponding to the respective types, but may not do so often.

When the size adjusted by the user is N+a, the value of N+a corresponds to a size between type N and type N+1.

When the final size N+a of the selection area 32a determined by the user is close to type N+1, the size of the selection area 32a is displayed in the size of type N+1 on the display screen, and information corresponding to type N+1 is also displayed (S216 and S220).

When the final size N+a of the selection area 32a determined by the user is close to type N, the size of the selection area 32a is displayed in the size of type N on the display screen, and information corresponding to type N is also displayed (S216 to S218).

On the other hand, when the size of the selection area is not phasic (see description with reference to FIG. 25), the selection area 32a or 32a′ is displayed in the size based on the result of the phasic operation command from the user on the screen of the display 30. However, when the size of the selection area is phasic, the selection area 32a is displayed in the size described with reference to steps S218 and S220 on the screen of the display unit 30.

The process flow illustrated in FIG. 27 can be performed by the terminal 110 or the server 100 like the flowchart illustrated in FIG. 26.

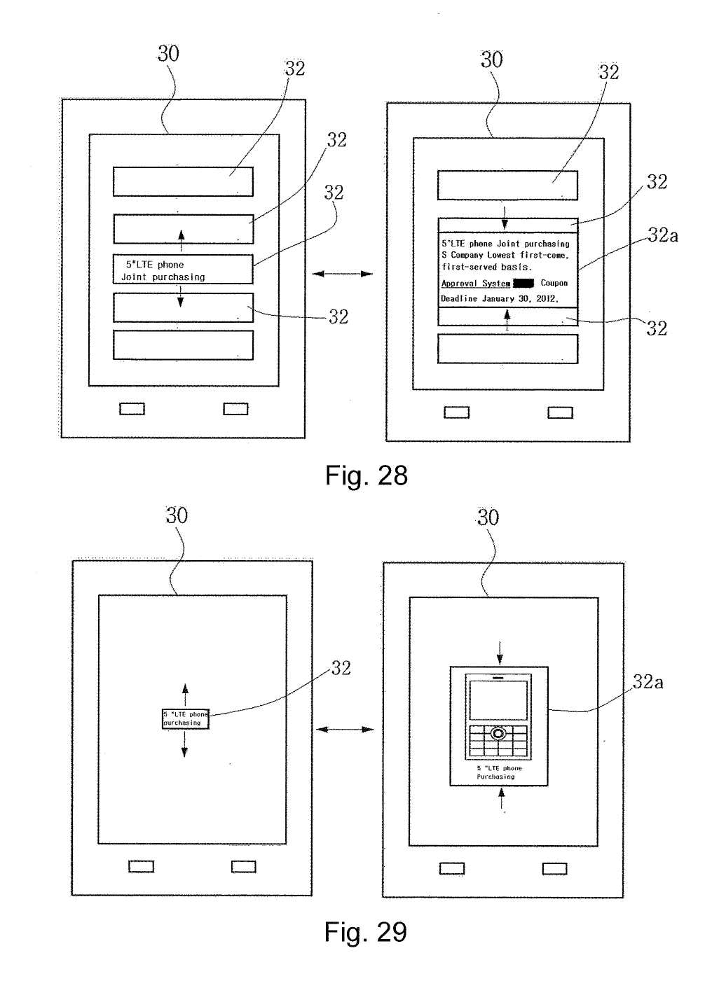

FIG. 28 is a diagram illustrating an example where two or more selection areas 32 to which a phasic operation command can be input can be displayed on the display. One selection area 32 thereof can be selected and a phasic operation command can be input.

### Embodiment 8

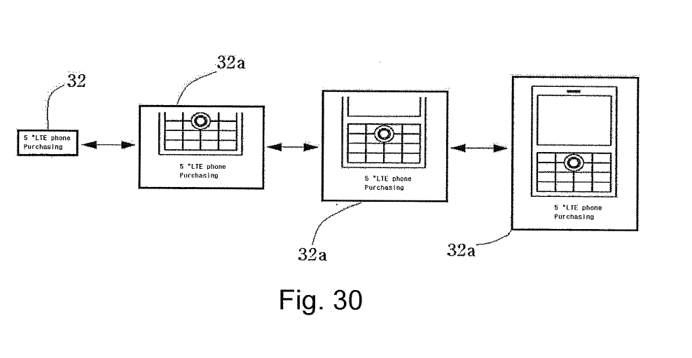

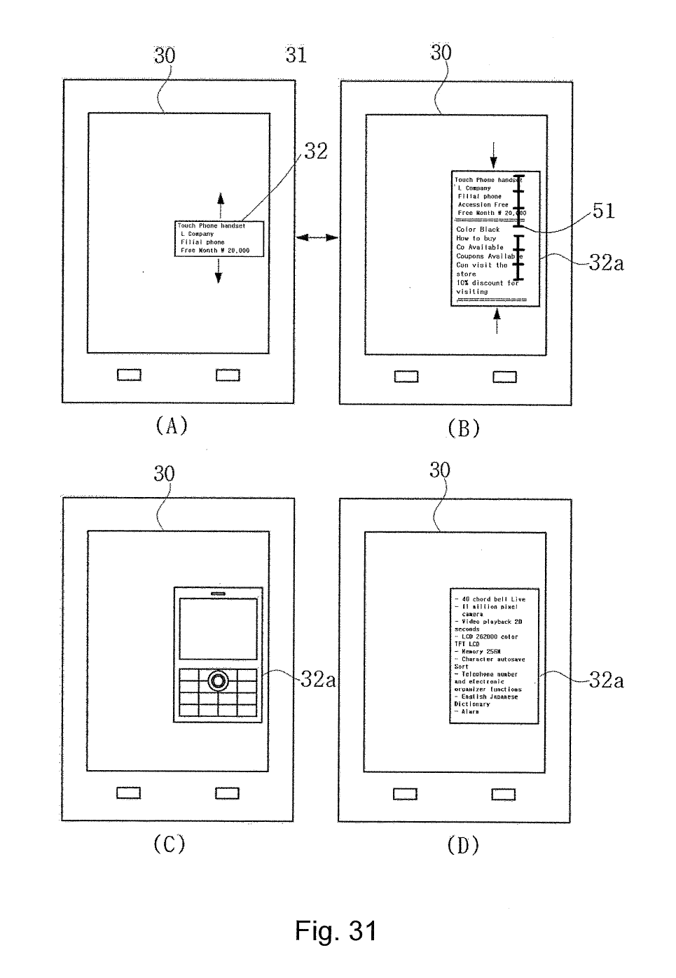

FIGS. 29 and 31 are diagrams illustrating an example where the details and the size of information can be changed variously.

When a phasic operation command is input to the selection area 32, the size of the selection area does not increase in proportion to the phases, but the size of the selection area can be determined depending on the size or type of data displayed in the selection area.

When information to be displayed is an image as in the example illustrated in FIG. 30, information can be displayed to correspond to the size of the selection area 32 changed by the phasic operation command.

FIG. 31 is a diagram illustrating an example where a phasic operation command with which the size of the selection area is changed and a phasic operation command with which the size of the selection area is not changed are input together.

### Embodiment 9

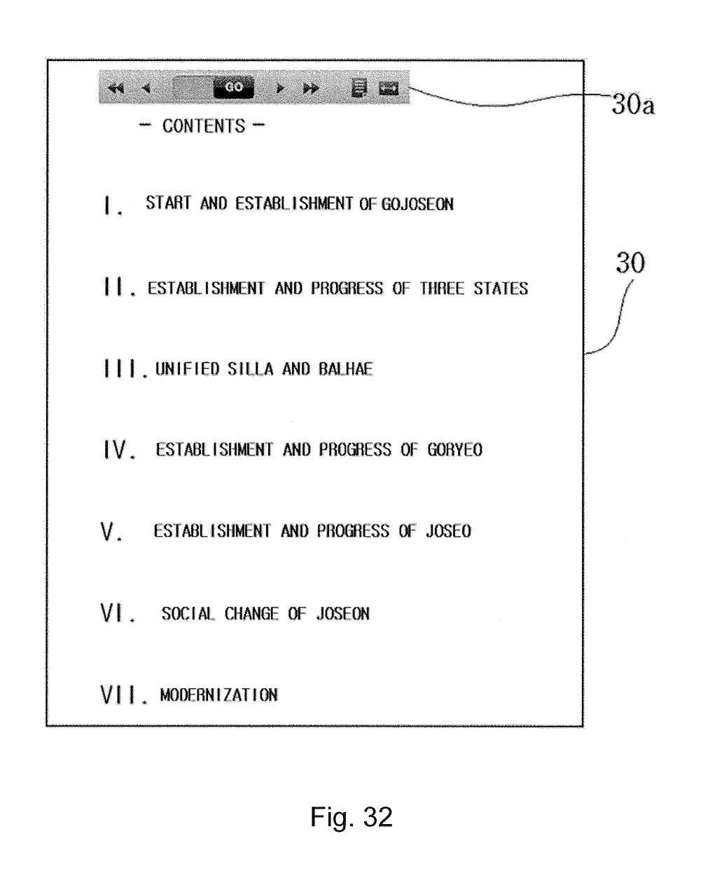

FIGS. 32 to 34 are diagrams illustrating an example where two or more selection areas are present on the screen.

That is, plural areas to which a phasic operation command can be input may be present on the display screen.

FIG. 32 is a diagram illustrating an example where general contents of a digital textbook are displayed. A menu bar 30a is displayed in the upper part of the display screen. All of items I to VII can be subjected to the input of a phasic operation command. Therefore, when one item of the items is selected and is subjected to a phasic operation command, information corresponding to the input result is displayed on the display screen.

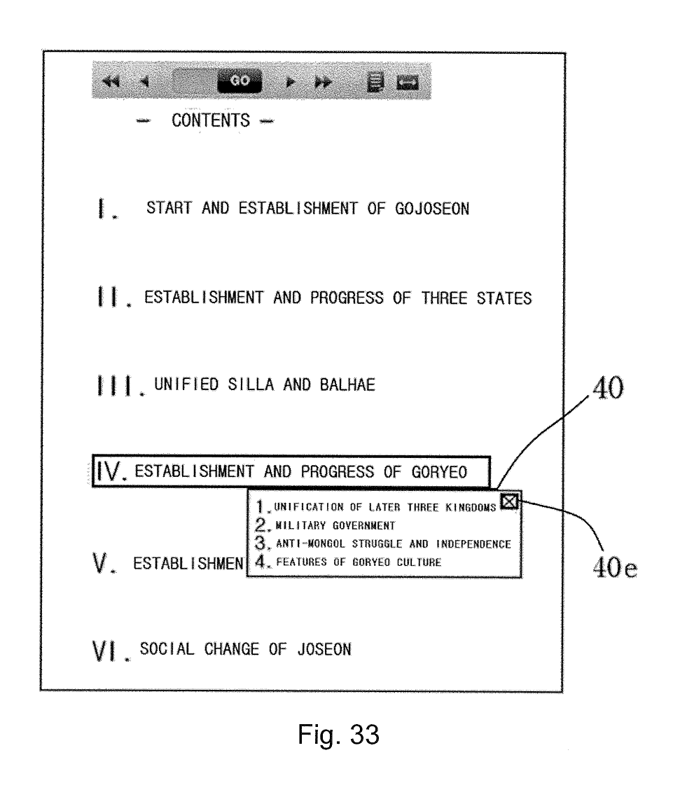

FIG. 33 is a diagram illustrating an example where one item is selected and the selected item is activated. The activation of an item in the present invention means that when the item of “ESTABLISHMENT AND PROGRESS OF GORYEO” is selected, the text is displayed on the display screen to vary in color or to flicker so as to be distinct from other texts. The central processing unit performs this process in accordance with a predetermined algorithm when information is input using the input unit.

When the item is selected and then moves by one phase in the + direction as in the example, information enlarged to the first phase in conjunction with “ESTABLISHMENT AND PROGRESS OF GORYEO” is displayed in a display window 40.

That is, when the information is divided into three phases as illustrated in FIG. 12 and the item of “ESTABLISHMENT AND PROGRESS OF GORYEO” is selected and moved by three phases in the + direction, information of the third phase is displayed in the display window 40. When the information of the first phase is displayed in the display window 40 and is moved by two steps in the + direction, information of the third phase is displayed. When the information is moved from the third phase by −2 phases, the information of the first phase is displayed.

Similarly, when another item of “UNIFIED SILLA AND BALHAE” is selected, information of different phases can be displayed in the same way.

On the other hand, by selecting an “x” mark 40a displayed in the upper part of the display window 40 in FIG. 33, the display window can be immediately closed. That is, even when information of any phase is displayed in the display window, the display window is closed or switched to the initial display phase (the first phase or the zeroth phase).

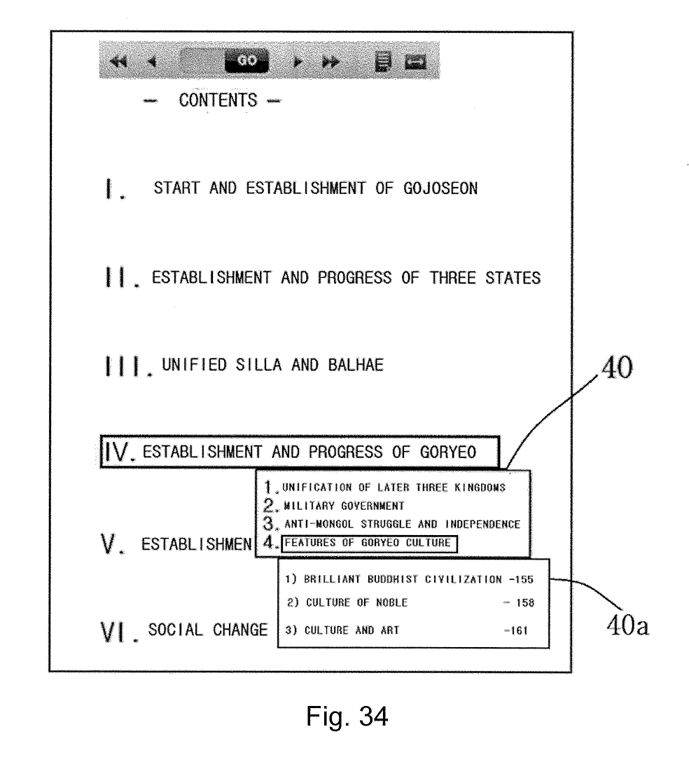

FIG. 34 is a diagram illustrating an example where a phasic operation command has a layered structure. As illustrated in FIG. 34, when the item of “ESTABLISHMENT AND PROGRESS OF GORYEO” is selected and is moved in the + direction by one phase, information of the first phase 40 connected to “ESTABLISHMENT AND PROGRESS OF GORYEO” is displayed in the display window 40.

When one item (for example, “FEATURES OF GORYEO CULTURE”) is selected in the list of information displayed in the first phase and is maintained for a predetermined time, only the item of “FEATURES OF GORYEO CULTURE” is activated as illustrated in FIG. 34. When the phasic operation command is input to the activated “FEATURES OF GORYEO CULTURE”, information of the phase associated with “FEATURES OF GORYEO CULTURE” is displayed in an additional display window 40a.

When one item is selected in the list displayed in the addition display window 40a, the selected page is displayed on the display screen.

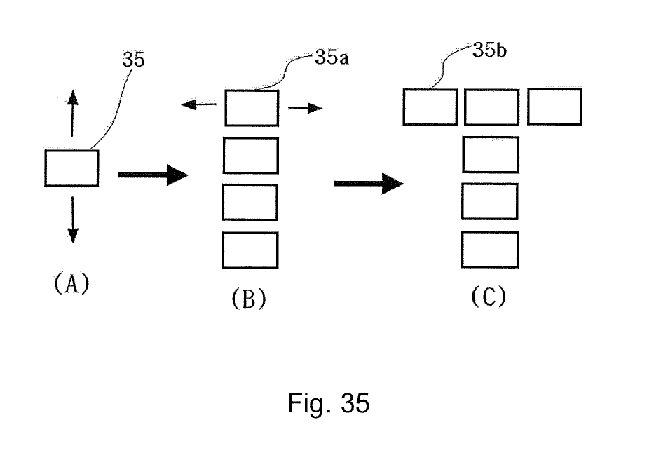

FIG. 35 is a diagram illustrating another example of a phasic operation command.

When a selection area 35 is present on the screen of the display 30 and moves in the + direction by inputting a phasic operation command to the selection area, additional information 35a is displayed in a column. When one item of the additional information 35a is selected and moves in the + direction by inputting a phasic operation command thereto, another additional information 35b is displayed in a row. The additional information is returned to the original state by movement in the − direction.

In addition, more additional information 35a (or another additional information 35b) is displayed in proportion to the moving distance in the + direction.

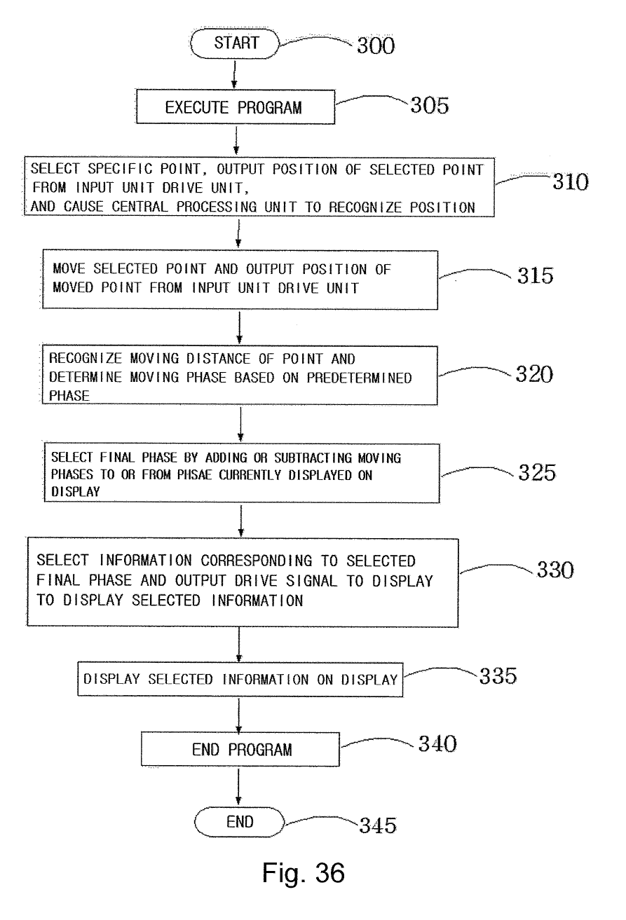

FIG. 36 is a flowchart illustrating a process flow of inputting and executing a phasic operation command.

The terminal 110 is booted and a program is executed which can control a phasic operation command from the input unit (S300 to S305).

When a user selects two specific points (or one point or two or more points) using the input unit 28, the input unit drive unit 27 outputs the positions of the selected points and the central processing unit 20 recognizes the positions of the selected points (S310).

When the selected points are moved using the input unit 28 that can input information on the screen of the display 30, the input unit drive unit 27 outputs the positions of the moved points. Then, the central processing unit 20 recognizes the moving distance of the points, determines the phase to which the points are moved, and determines the phase of the control command as a result (S315 to S320).

On the other hand, when the terminal performs the processes of steps S310 to S320 with the server connected thereto, the performing process can be divided as follows.

First, the central processing unit of the terminal transmits the positions of the points and the movement information output from the input unit drive unit 27 to the server, and the control unit 101 of the server determines the phase of the control command.

Second, the central processing unit 20 of the terminal recognizes the positions of the points and the movement information output from the input unit drive unit 27, and the central processing unit 20 of the terminal determines the phase of the control command, and transmits the determined phase of the control command to the server.

Transmission and reception of data between the terminal and the server is performed using a communication network by the interface unit 102 of the server and the R/F unit 24.

Thereafter, the central processing unit 20 adds or subtracts the moving phases based on the operation command to or from the phase of the information currently displayed on the screen of the display 30 to determine a final phase. Information corresponding to the final phase is displayed on the screen of the display. That is, the central processing unit 20 outputs a display drive signal for displaying the newly-selected information, and the newly-selected information is displayed on the screen of the display 30 (S325 to S335).

For example, when the phase of information current displayed on the screen of the display is the first phase and a control command of +2 phases is input, the finally-selected phase is the third phase and information of the third phase is displayed on the screen of the display. When the phase of information currently displayed on the screen of the display is the fourth phase and a control command of −2 phases is input, the finally-selected phase is the second phase and information of the second phase is displayed on the screen of the display.

This process is divided depending on the connection between the terminal and the server as follows.

First, in a state where the terminal is not connected to the server, the central processing unit 20 determines the final phase, selects information corresponding to the final phase from the memory unit 21, and displays the selected information on the display screen.

Second, when the terminal is connected to the server, the control unit 101 of the server selects information corresponding to the final phase from the database unit 104 of the server and transmits the selected information to the terminal, and the central processing unit of the terminal displays the information transmitted from the server on the display screen.

This process is performed by causing the central processing unit to select the information stored in the memory unit. An algorithm enabling this process is also stored in the memory unit. Information corresponding to the respective phases is stored in the memory unit 21.

When the control unit of the server performs the above-mentioned process, the information corresponding to the respective phases is stored in the database unit 104 of the server and the algorithm thereof is also stored in the database unit.

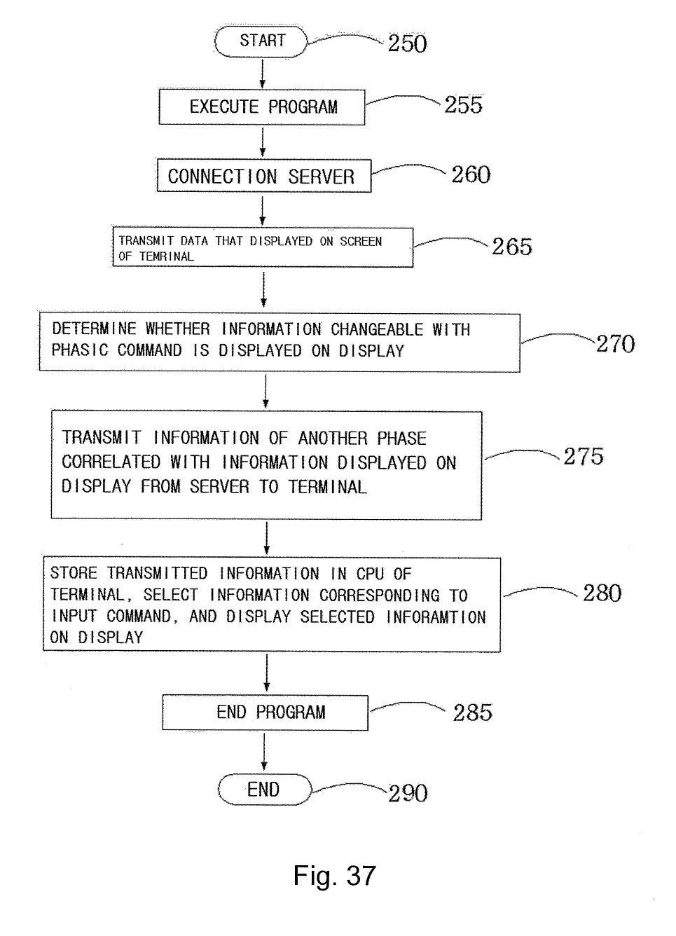

FIG. 37 is a flowchart illustrating an example where information corresponding to the respective phases is transmitted from the server.

When the terminal is booted and executes a program to access the server, the control unit 101 of the server 100 selects information to be displayed on the screen of the display 30 of the terminal 110 from the database unit 104 and transmits the selected information to the terminal via the wired/wireless communication network (or the Internet).

Then, when the central processing unit 20 of the terminal outputs a display drive signal on the basis of the transmitted information, the display 30 displays the information transmitted from the server (S250 to S265).

At this time, it is determined whether a phasic operation command can be input to the screen displayed on the display as a whole. When a selection area is present on the display screen, it is determined whether the selection area can be subjected to the input of the phasic operation command. That is, when the phasic control command can be input to the display screen, the server transmits another information connected to the display screen to the terminal (S270 to S275).

That is, in the example illustrated in FIG. 24, when information of type 1 (first phase) is currently displayed on the display screen, the server transmits information of types 2 to N to the terminal.

When the display screen of the information transmitted from the server to the terminal can be subjected to the input of a phasic operation command, the server transmits information of other phases connected to the information displayed on the screen to the terminal.

The central processing unit 20 of the terminal stores the transmitted information in the memory unit 21, determines the final phase according to the embodiment of the present invention when a phasic operation command is input using the input unit 28, selects information corresponding to the final phase, and displays the selected information on the display screen (S280). On the other hand, when the program ends and the termination switch is turned off, the terminal ends the process flow (S285 to S290).

### INDUSTRIAL APPLICABILITY

According to the present invention, it is possible to provide information by phases when a phasic operation command is input onto the display unit through the input unit with a finger or operation means, to provide plural phases of information on the same screen without switching the screen, and to provide information stored in another Internet site or at another storage position and correlated with the information displayed on the screen.

1. A phasic information providing system and method in a terminal including a display unit, a central processing unit, and an input unit,
wherein when a phasic operation command having a specific phase is input onto the display unit, the input unit outputs the phasic operation command, and
wherein the central processing unit recognizes the phase of the phasic operation command and outputs information corresponding to the recognized phase to the display unit.

2. The phasic information providing system and method according to claim 1, wherein when a point is selected on the display unit, the point moves, and information on the moving distance is output, the central processing unit determines the moving distance to be a phase.

3. The phasic information providing system and method according to claim 1, wherein when a point is selected on the display unit, the point rotates, and information on the rotational movement is output, the central processing unit determines the angle of the rotational movement to be a phase.

4. The phasic information providing system and method according to claim 1, wherein the phase includes + moving phases.

5. The phasic information providing system and method according to claim 1, wherein the phase includes − moving phases.

6. The phasic information providing system and method according to claim 1, wherein when two points are selected through the use of the input unit, the phase is determined with a variation in a distance between the two points.

7. A phasic information providing system and method in a terminal including a display unit, a central processing unit, and an input unit,
wherein the terminal is connected to a server including a database and a control unit,
wherein when a phasic operation command having different phases is input onto the display unit, the input unit outputs the phasic operation command and the central processing unit recognizes the phase of the phasic operation command and outputs information corresponding to the recognized phase to the display unit,
wherein the central processing unit transmits information on the phase of the phasic operation command to the server or transmits a phasic operation command signal from the input unit to the server, and
wherein the server transmits the information on the phase from the database to the terminal.

8. The phasic information providing system and method according to claim 1, wherein when a point is selected on the display unit, the point moves, and information on the moving distance is output, the central processing unit determines the moving distance to be a phase.

9. The phasic information providing system and method according to claim 1, wherein when a point is selected on the display unit, the point rotates, and information on the rotational movement is output, the central processing unit determines the angle of the rotational movement to be a phase.

10. The phasic information providing system and method according to claim 1, wherein the phase includes + moving phases.

11. The phasic information providing system and method according to claim 1, wherein the phase includes − moving phases.

12. The phasic information providing system and method according to claim 1, wherein when two points are selected through the use of the input unit, the phase is determined with a variation in a distance between the two points.

13. The phasic information providing system and method according to claim 1, wherein when a current phase is N and the point moves by +J phases, a finally-selected phase is N+J.

14. The phasic information providing system and method according to claim 1, wherein when a current phase is N and the point moves by −I phases, a finally-selected phase is N−I.
